(19) United States
(12) Patent Application Publication
(10) Pub. No.: US 2004/0139713 A1
(43) Pub. Date: Jul. 22, 2004

(54) Leaf removal process using netted blanket

(76) Inventor: Chu Ng, Woodbridge, NJ (US)

Correspondence Address: Chu Ng, 124B Beverly Hill Terrace, Woodbridge, NJ, 07095, US

(21) Appl. No.: 10/348,221

(22) Filed: Jan. 22, 2003

(51) Int. Cl. A01D 1/00

(52) U.S. Cl. 56/1

(57) ABSTRACT

A leaf removal process using a netted blanket is provided in this invention. This process comprises the following steps: a) the netted blanket is spread over the lawn; b) then the user waits for the leaves to fall on the netted blanket; and c) when enough leaves have fallen on to the blanket, the leaves are removed and disposed by lifting/folding/rolling/dragging the netted blanket. The netted blanket can be made from a non-biodegradable material and can be re-used one or more times. It can also be made from a disposable biodegradable material. When the biodegradable netted blanket is used, the folded/rolled/lifted netted blanket with the leaves in it can be tied up with twine or other suitable material for disposal; therefore it is time saving because there is no need to fill bags or cans with leaves for disposal. Often times, filling the bags with leaves is the time consuming task of the leaves removal process.

### CROSS-REFERENCE TO RELATED APPLICATIONS

References Cited [Referenced By]

U.S. Patent Documents

| | | | |
|---|---|---|---|
| 2504943 | April 1950 | Zifferer | 56/400. |
| 2908131 | October 1959 | Ross | 56/400. |
| 3350886 | November 1967 | Spencer | 56/400. |
| 3688484 | September 1972 | Cox | 56/400. |
| 4037394 | July 1977 | Fiorentino | 56/400. |
| 4057277 | November 1977 | Burkholder | 56/400. |
| 4378671 | April 1983 | Gascon | 56/400. |
| 4427227 | January 1984 | Haskell | 294/50. |
| 4741149 | May 1988 | vom Braucke et al. | 56/400. |
| 4791780 | December 1988 | Phillips | 56/400. |
| 4991386 | February 1991 | Dirksen | 56/400. |
| 5564267 | May 1995 | Bricker et al. | 56/400 |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention is directed to a leaf removal process using netted (meshed or open-weaved) blanket.

U.S. Pat. No. 5,564,267 has a good description of the problem in which the present invention is intended to solve: “Residential areas filled with deciduous trees experience the splendor of autumn every year as the leaves change color. However there is a price to pay as autumn progresses and the leaves fall to the ground. Homeowners find themselves saddened with the task of removing the leaves from their lawn. The typical process of removing leaves involves raking or blowing the leaves into piles and then filling bags or cans with the leaves for disposal. The process of leaning down and bending over to pick up leaves from a pile can be difficult work that leads to muscle fatigue and pain.”

2. Description of Related Art

Numerous tools have been developed which attempt to ease the process of leaf removal. All of these inventions are the raking tools. None of these inventions use a netted blanket for disposing of leaves. Some of these related inventions are:

1. U.S. Pat. No. 2,504,943 (Zifferer) discloses a pickup broom rake with a spring loaded swinging rake head which can cooperate with a fixed rake head to close upon and grip a pile of leaves.

2. U.S. Pat. No. 2,908,131 (Ross) discloses two rakes pivotally attached to one another. Ross describes using the combination rake in a closed position as a rake. The combination tool can be opened and closed to pick up leaves.

3. U.S. Pat. No. 3,688,484 (Cox) discloses a garden tool with two rakes pivotally connected. The two rake heads of the Cox tool face each other for lifting leaves.

4. U.S. Pat. No. 4,037,397 (Fiorentino) discloses a lawn rake with a second short-handled rake pivoted upon the first rake. The rake heads face each other for picking up debris.

5. U.S. Pat. No. 4,378,671 (Gascon) discloses a rake with a rotatable rake head. A second pivotally attached rake head is used for picking up debris with the rake heads facing one another. The combination rake is stored with the rake heads facing the same direction.

6. U.S. Pat. No. 4,991,386 (Dirksen) discloses a pair of rakes pivotally connected for picking up leaves between two facing rake heads.

All the leaf removal tools heretofore are known to suffer from a number of disadvantages:

1. The tools heretofore are complex mechanical machines.

2. The tools heretofore are expensive for an average residential/industrial customer.

3. Operating the tools heretofore may not be labor intensive, however, they are time consuming.

### BRIEF SUMMARY OF THE INVENTION

This invention does not employ the conventional methods (such as blowing and raking) in removing the leaves from the lawn. This invention uses a netted blanket with small holes in the following process:

1. The netted blanket is spread over the lawn (preferably leaf-free lawn), and optionally anchored down on the edges of the netted blanket.

2. Then the user waits for the leaves to fall on the blanket. When enough leaves have fallen on to the blanket, the leaves are removed and disposed by lifting up or rolling up the netted blanket with all the leaves in it.

The netted blanket can be made of a non-biodegradable material and is re-used one or more times. The netted blanket can also be made of a disposable biodegradable material and is used once.

When the biodegradable netted blanket is used, the said folded/rolled/lifted netted blanket with the said leaves in it shall be tied up with twine or other suitable material for disposal; therefore it is time saving because there is no need to fill bags or cans with leaves for disposal. Often times, filling the bags with leaves is the time consuming task of the leaves removal process. The present invention is not limited for residential use; it can deploy in the commercial area. The process of this invention heretofore has a number of advantages over the prior related arts:

1. The process of this invention is simple;

2. The netted blanket material used in this invention is inexpensive for an average residential customer; and

3. The process of this invention is a time saving.

### BRIEF SUMMARY OF THE SEVERAL VIEWS OF THE DRAWING

This invention and its mode of operation will be more clearly understood from the following detailed description when read with the appended drawing in which:

FIG. 1 illustrates a lawn that's covered by pieces of the netted blankets to provide full coverage of the lawn, in accordance with the principles of the present invention;

FIG. 2 shows a process in a folding of the netted blankets, in accordance with the principles of the present invention.

Throughout the drawing, the same element when shown in more than one figure is designated by the same reference numeral.

### DETAILED DESCRIPTION OF THE INVENTION

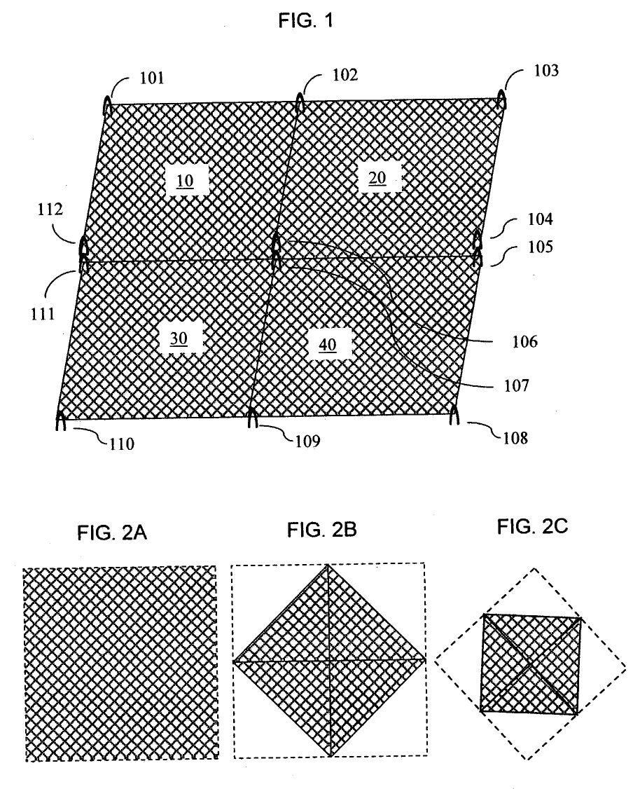

Reference now FIG. 1 of the drawing, there is shown multiple netted blankets 10 through 40, and the anchoring devices 101 through 112. Although four netted blankets are shown and described herein, it is to be understood that a greater or fewer number of netted blankets may be employed in practicing the principles of this invention. In accordance of the principle of this invention, as many netted blankets would be used to provide the full coverage of the surface. For example, to cover the 10 feet by 100 feet size lawn, one could use ten pieces of ten feet by ten feet netted blankets.

The smaller pieces of netted blankets are used to facilitate the ease of lifting or folding process that will be employed in a later step.

In accordance with the disclosed embodiment, the netted blankets 10 through 40 are anchored down by the anchoring devices 101 through 112. This is to keep the netted blankets in place as the next step in the process is to wait for the leaves to fall on to the netted blanket. The waiting time depends on the leaves falling rate and how often the user wishes to remove the leaves (the waiting time may be from one day to four weeks).

In accordance with the disclosed embodiment, the user may optionally anchor down the netted blanket. Those who are skilled in the art could design a suitable anchoring devices for the boundary of the netted blankets. In the case of the overlapping netted blankets, one may want to use the clipping devices.

In accordance with the disclosed embodiment, when enough leaves (depends on the user's desire) are fallen on the netted blanket, the user un-anchors the netted blankets and removes the leaves by lifting up (via folding, rolling up and etc.) the netted blanket with the leaves in it.

In accordance with the disclosed embodiment, the netted blanket can be made from durable re-usable material and can be re-used one or more times. For re-usable netted blanket, the user lifts the leaf-filled netted blanket and dumps the leaves on the curb for leaf collection. Then the netted blanket can be re-used again.

In accordance with the disclosed embodiment, the netted blanket can be made from a disposable biodegradable material. For the disposable biodegradable netted blanket, the user could dispose the leaves by:

a. Lifting up the netted blanket and dumping the leaves on the curb,

b. Folding up the netted blanket with the leaves in it and cross tied the bundle with twine or other suitable material before disposing of it on the curb,

c. Rolling up the netted blanket with leaves in it and cross tied the bundle with twine or other suitable material before disposing of it on the curb, or

d. Pre-attaching a loose string along the edges of the netted blanket so that by pulling up the string the user can gather up the netted blanket on its edges and the netted blanket forms a closed ball before disposing of it on the curb.

Reference now to FIG. 2A, FIG. 2B, and FIG. 2C of the drawing, there is shown one of many ways of removing the leaves by folding up the netted blanket.

In accordance with the disclosed embodiment, as shown in FIG. 2A, FIG. 2B, and FIG. 2C, the corners of the netted blanket are folded toward the center of the netted blanket and cross tied the bundle with twine or other suitable material. It is ready to be placed on the curb for leaf collection. It is time saving because there is no need to fill bags or cans with leaves for disposal. Often times, filling the bags with leaves is the time consuming task of the leaves removal process.

Reference again to FIG. 2A of the drawing, there is shown the netted blanket. In accordance with the disclosed embodiment, the primary reason for using a netted blanket is the netted blanket might be remained on the lawn for a period of time (for example, from one day to four weeks), so the netted blanket shall be designed in such a way to minimize the blocking of the sunlight to the grass by the netted blanket. For example, a practitioner who is skilled in the art could design the said netted blanket in open weaves (holes) with thin threads, provided that the holes are smaller than the leaves or other debris (such as pine cones or fruits) that the said blanket is intended to hold.

The secondary reason for using a netted blanket is the said netted blanket would not hold water from the rainfall. This way when lifting up the netted blanket, it would not be heavy with water.

This leaf removal process is not limited to lawn surfaces and may be used on any surface, such as sandy surface in a desert garden, concrete surfaces, ponds, swimming pools, patios, gutters, and etc.

It is to be understood that various modifications of this invention are possible and may obviously be resorted to by those skilled in the art without departing from the spirit and the scope of the invention as hereinafter defined by the appended claims.

We claim:

1. A method for removing leaves comprising the following steps:
a. The user spreads a netted blanket over the lawn or other surface and optionally anchors it down on its edges;
b. The user waits for the leaves to fall on the said netted blanket;
c. When enough said leaves have fallen on to the said netted blanket, the user un-anchors the said netted blanket and removes the said leaves by lifting up (via folding, rolling up, dragging and etc.) the said netted blanket with the said leaves in it.

2. The process of lifting up the said netted blanket (in claim 1 step c) may be designed by those who are skilled in the art.

3. The said netted blanket in claim 1 can be made from a re-useable (biodegradable or non-biodegradable) material and can be re-used one or more times.

4. When the said netted blanket used in claim 1 is a re-usable material, the said netted blanket with the said leaves in it (in claim 1 step c) may have the said leaves removed from the said netted blanket for disposal in accordance to the local township recycle law.

5. The said netted blanket in claim 1 can also be made from a disposable biodegradable material.

6. When the said netted blanket used in claim 1 is made with a disposable biodegradable material, the said netted blanket in claim 2 shall be disposed in accordance to the local township recycle law.

7. When the said netted blanket used in claim 1 is made with a disposable biodegradable material, the folded/rolled/lifted said netted blanket with the leaves in it can be tied up with twine or other suitable material for disposal; therefore it is time saving because there is no need to fill bags or cans with leaves for disposal.

8. Since the said netted blanket in claim 1 (step b) might be remained on the lawn for a period of time, the said netted blanket should be designed in such a way to minimize the blocking of the sunlight to the grass of the said lawn by the said netted blanket.

9. Further advantage of the said netted blanket in claim 1 is to aid in the removal of wet leaves or debris by allowing the water to drain which, in turn, reduces the weight.

10. To completely cover the said lawn in claim 1, depending on the size of the said lawn, the said netted blanket in claim 1 could be made up of smaller pieces of netted blankets to facilitate for the ease of folding/lifting/rolling up in claim 1 step c.

11. To keep the said netted blankets in claim 10 in place, optional anchoring devices are used to anchor the said netted blankets at their four sides; a practitioner who is skilled in the art should design the suitable said anchoring devices.

12. The said lawn in claim 1 may be any surface.

13. When spreading the said netted blanket in claim 1 step a, the user may encounter obstacles (such as trees, brushes and etc); in this case, the said netted blanket may be trimmed so that it gets around the said obstacles.

14. The said leaves in claim 1 may not be limited to leaves and may be any kind of debris (such as pine cones, fruits, and etc).
